(19) United States
(12) Patent Application Publication
(10) Pub. No.: US 2002/0054025 A1
(43) Pub. Date: May 9, 2002

(54) Electronic equipment, recording medium and method for generating images and/or sound

(76) Inventor: Nobuhiro Komata, Tokyo (JP)

Correspondence Address: HELFGOTT & KARAS, P.C., 60th Floor, Empire State Building, New York, NY, 10118-0110, US

(21) Appl. No.: 09/758,044

(22) Filed: Jan. 10, 2001

(30) Foreign Application Priority Data
Jan. 14, 2000 (JP) 2000-40273

(51) Int. Cl. G09G 5/00

(52) U.S. Cl. 345/173

(57) ABSTRACT

Electronic equipment includes a processing apparatus that performs high-speed playback processing depending on an output of a switch pushed by a user of the electronic equipment. The processing apparatus changes the playback speed to a speed that depends on an output value of the switch. A recording medium is used which has a program that changes the playback speed depending on the output value of the switch. A method of generating images and sound senses the pushing pressure applied by a user to a switch by a pressure-sensitive unit to generate a pressure-sensing signal, determines a playback speed according to a pressure-sensing signal, and performs variable-speed playback at the determined playback speed.

### FIELD OF THE INVENTION

The present invention relates to electronic equipment, a recording medium and a method for generating images or sound to make the pushing of simple ON/OFF switches and/or continuous pushing thereof by a user for the purpose of variable-speed playback, into an easier-to-use user interface.

### BACKGROUND OF THE INVENTION

For the purpose of so-called variable-speed playback wherein, during the playback of media recorded with sound and/or images by electronic equipment, the playback speed is changed from the normal playback speed, specialized switches for variable-speed playback may be provided on the remote control or the front panel of the equipment, for example. These switches may be ON/OFF switches, rotary switches and the like, each of which provides instructions based on the ON period or duration of the ON period to the electronic equipment, which may be a compact disc player, a compact cassette recorder, a digital audio tape recorder, a video tape recorder, a hard disk recorder or the like.

On the other hand, the so-called pressure-sensitive type controllers are used as input devices for electronic equipment represented by computers, and as input devices for entertainment systems represented by game machines, for example. A pressure-sensitive controller is a unit wherein, when pressure is applied with a finger of a user directly to a control element connected to a pressure-sensitive device of the controller and the pushing pressure of the user applied to the control element is provided as output as a pressure-sensing value. A specific example thereof is, for example, a pressure-sensitive type controller disclosed in the publication of examined Japanese utility model application No. JP-B-H1-40545, wherein pressure-sensitive output is provided as input to a VCO (variable control oscillator) and the output of the VCO is used for repeated fire in a game.

### SUMMARY OF THE INVENTION

It is an object of the present invention to make the pushing or continuous pushing of a simple ON/OFF switch by a user for the purpose of variable-speed playback into an easier-to-use user interface.

This and other objects of the invention are attained by electronic equipment which comprises a switch, pressure-sensing means to which said switch is connected; a processing apparatus that performs high-speed playback processing at a speed depending on a output value of said switch, and output means that outputs the results of processing of said processing apparatus, said processing apparatus changing a playback speed to a speed that depends on the output value of said switch.

A recording medium according to the present invention on which is recorded a computer-readable and executable software program that performs processing by taking as instructions an output from a controller which has pressure-sensitive means, wherein said software program changes a playback speed depending on the output value of the switch.

A method of generating images and sound according to the present invention comprises the steps of, sensing a pushing applied by a user on pressure-sensitive means by said pressure-sensing means to generate a pressure-sensing signal, determining a playback speed in accordance with said pressure-sensing signal, and performing variable-speed playback at the playback speed thus determined.

### BRIEF DESCRIPTION OF THE DRAWINGS

FIG. 1 is a schematic diagram showing connection of a controller to an entertainment system;

FIGS. 2A-2B are diagrams for explaining three kinds of pictures, an I picture, P picture and a B picture;

FIGS. 3A and 3B show table used for playback, where FIG. 3A is a table for high-speed playback while FIG. 3B shows a table for low-speed playback;

FIG. 4 is a flowchart of the processing of a program for performing variable-speed playback;.

FIG. 5 is a flowchart of the high-speed playback processing routine S100 shown in FIG. 4;

FIG. 6 is a flowchart of the low-speed playback processing routine S200 shown in FIG. 4;

FIG. 7 is a block diagram of an entertainment system which uses pressure-sensing values for the variable-speed playback of a compact cassette recorder;

FIG. 8 is a perspective view of the controller connected to the entertainment system;

FIG. 9 is a block diagram of the entertainment system;

FIG. 10 is a top plan view of the controller;

FIG. 11 is an exploded perspective view of the second control part of the controller;

FIGS. 12A-12C are cross sectional views of the second control part of FIG. 11;

FIG. 13 is a diagram showing an equivalent circuit for a pressure-sensitive device;

FIG. 14 is a block diagram of the main parts of the controller;

FIG. 15 is an exploded perspective view of the first control part of the controller;

FIG. 16 is a cross sectional view of the first control part of FIG. 15;

FIG. 17 is a diagram showing the circuit configuration of a resistor;

FIG. 18 is a graph showing the characteristic of the signal output;

FIG. 19 is a block diagram showing the overall constitution including the resistor;

FIG. 20 is an exploded perspective view of the third control part of the controller.

### DETAILED DESCRIPTION OF THE PREFERRED EMBODIMENT

In a controller that uses a pressure-sensitive device, when the button which is the control element is pushed by a user, not only the presence of pressure-sensing output is detected, for example, as the ON/OFF of a switch, but also a pressure-sensing value output which depends on the pushing pressure of the user is also obtained. On the other hand, in software or games that use pressure-sensing value output, various processing or actions can be entered depending on the pressure-sensing value output. In this embodiment, even when playback is performed by operating a control element by the user, it is possible to change the playback speed depending on the pressure-sensing values based on the pushing operation of various control elements.

In the present embodiment, playback is performed at a speed depending on the pressure-sensing values output when a controller which has a pressure-sensitive device is operated. Thereby, it is intended to provide a system with a user interface that is improved in comparison to the repetitive or continuous ON action of a simple ON/OFF switch.

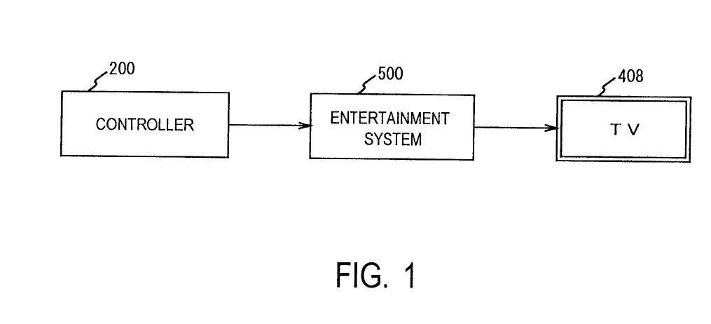

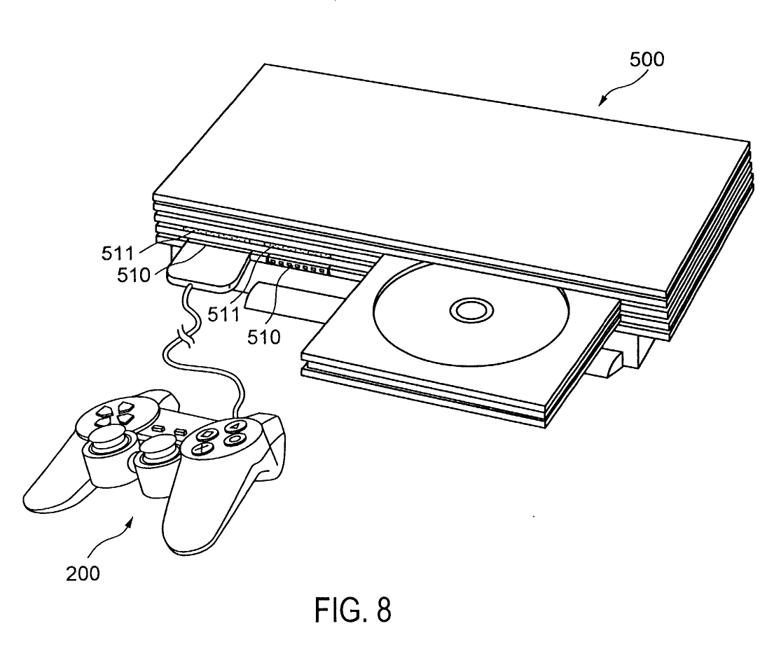

FIG. 1 is a schematic diagram showing the connection of a controller to an entertainment system to enable a user to enjoy game software or video in order to describe an overview of this preferred embodiment. More specific structure is shown in FIG. 8 and other figures.

As shown in FIG. 1, a controller 200 which has buttons connected to pressure-sensitive devices is connected to an entertainment system 500 used for playing games or enjoying DVD video or other types of video images, and the video output terminals are connected to a television monitor 408. Here, the analog output from the pressure-sensitive devices is converted by an A/D converter to digital values in the range 0-255 and provided to the entertainment system 500.

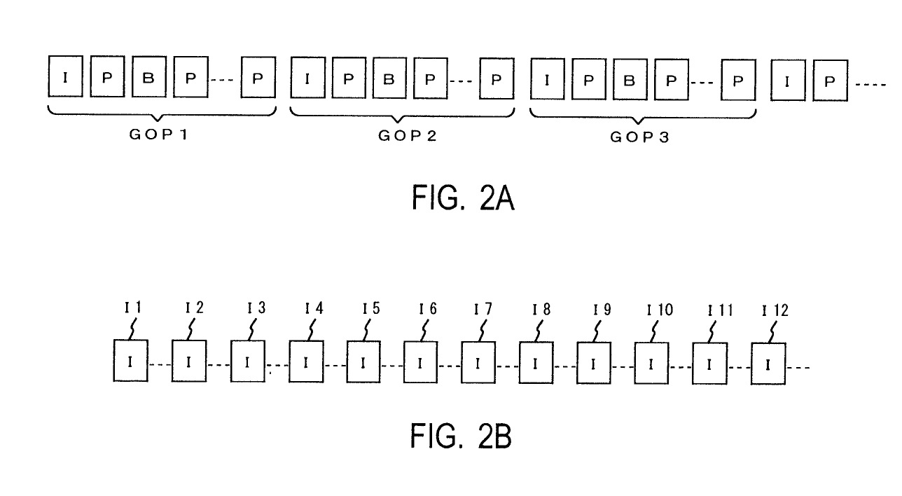

With reference to FIGS. 2-6, here follows a description of the case of performing variable-speed playback by the operation of the controller 200. As an example, a case in which video images recorded on DVD are subjected to variable-speed playback by the entertainment system 500 shown in FIG. 1 will be described.

In order to create a DVD on which video images are recorded, the edited video images to be recorded are compressed and recorded upon a hard disk or the like, and data read out from this hard disk must be used to create the DVD master.

The MPEG (Moving Picture Experts Group) standard is used for compression. As is common knowledge, in MPEG, the difference from the previous image and motion vectors are found, and DCT (discrete cosine transform) or other orthogonal transform processing is applied to the differential and holding same, and at the time of playback, IDCT (inverse discrete cosine transform) and motion compensation processing can be applied to obtain the original image.

As shown in FIGS. 2A, 2B as the types of image or picture, the three types of the I picture, P picture and B picture are defined. An I picture is a basic image to which only an orthogonal transform is applied, while a P picture is a differential image between the previous and subsequent images, and a B picture is an average picture of the previous and subsequent images.

Normally, at the time of authoring, in order to handle a scene change, namely when a basic image is followed by images of different content, the I picture serving as the basis is grouped with a series of N images.

As shown in FIG. 2A, such a unit group is called a GOP (Group of Picture).

In this embodiment, in order to handle variable-speed playback and high-speed playback in particular, only I pictures are used. When P pictures or B pictures are used, it is necessary to perform motion-compensation processing, so there is a high probability that this may not be done in time during high-speed playback.

Namely, as shown in FIG. 2B, a search is made for only I pictures, and for double-speed playback, it is sufficient to play back and output only every other I picture, in the manner I1, I3, I5, . . . , I11, or for half-speed playback, it is sufficient to play back the same I picture twice, in the manner I1, I1, I2, I2, . . . , I11, I11.

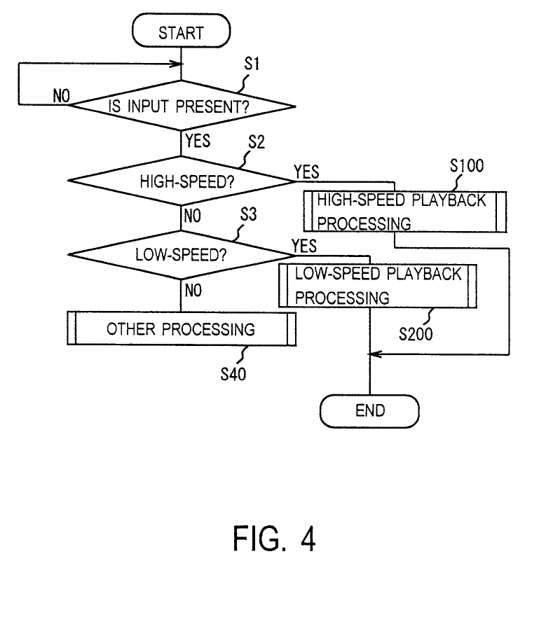

The specific method is described later in detail in reference to the flowcharts in FIGS. 4-6.

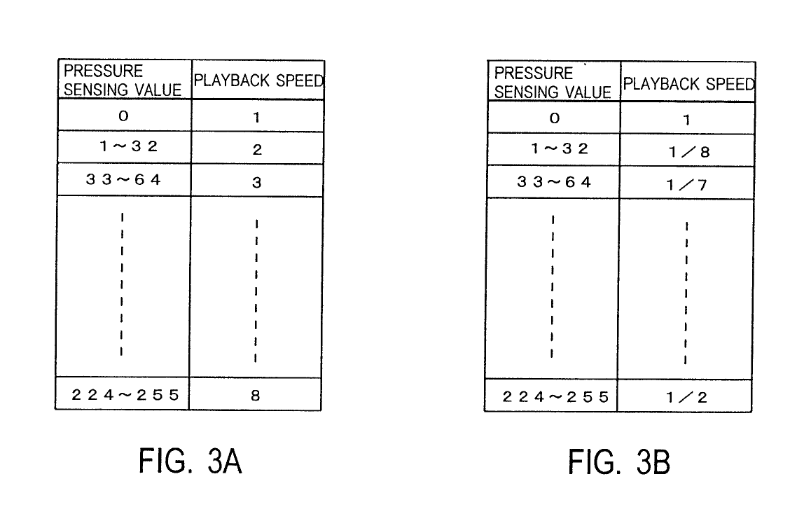

FIG. 3A shows a table for high-speed playback used to select the playback speeds 1, 2, . . . , 8 corresponding to pressure-sensing values of 0, 1-32, . . . , 224-255 from the controller.

In addition, FIG. 3B shows a table for low-speed playback used to select the playback speeds 1, ⅛, . . . , ½ corresponding to pressure-sensing values of 0,1-32, . . . , 224-255 from the controller.

With reference to FIGS. 4-6, the method of performing playback at a speed depending on the pressure-sensing value will be described. The flowchart shown in FIG. 4 illustrates the processing of a program for variable-speed playback.

In FIG. 4, in Step S1, a decision is made as to whether or not input is present and if “YES” then control moves to Step S2, where a decision is made as to whether or not high-speed playback is to be performed and if “YES” then control processing moves to the high-speed playback processing routine in Step S100, but if “NO” then control processing moves to Step S3, where a decision is made as to whether or not low-speed playback is to be performed and if “YES” then control processing moves to the low-speed playback processing routine in Step S200, but if “NO” then control processing moves to another processing routine S40.

Here, the decisions about high-speed playback or low-speed playback may be made by at least the following two conceivable methods. The first method is to provide both a pressure-sensitive switch used for high-speed playback and a pressure-sensitive switch used for low-speed playback, respectively. The second method is to provide a switch for switching between high-speed playback and low-speed playback, and each time this switch is pushed, by a user, the switch switches from high-speed playback to low-speed playback and from low-speed playback to high-speed playback, thereby switching the playback mode.

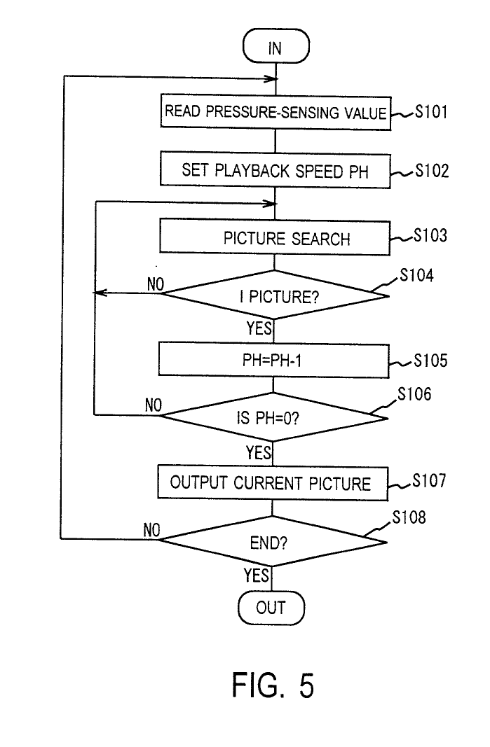

FIG. 5 is a flowchart showing the high-speed playback processing routine S100 shown in FIG. 4.

In Step S101, the pressure-sensing value is acquired from the controller 200, and in Step S102 the playback speed PH based on the pressure-sensing value thus acquired is read from the high-speed playback table shown in FIG. 3A and set.

In Step S103, a search for I pictures is performed among the pictures sequentially played back and restored, and in Step S104 a decision is made as to whether or not it is an I picture, and if “YES” then control processing moves to Step S105, but if “NO” then control processing moves back to Step S103.

In Step S105, the playback speed PH is decremented by 1, and in Step S106 a decision is made as to whether or not the decremented playback speed PH is equal to 0, and if “YES” then control processing moves to Step S107, but if “NO” then control processing moves back to Step S103.

In Step S107 the current picture, namely the I picture found in the search, is provided as output.

In Step S108, a decision is made as to whether to end or not. If “YES” then control processing leaves this routine, but if “NO” then control processing moves back to Step S101. The order to end may be given by input from a specialized switch or when the pressure-sensing value becomes 0.

Based on the processing of Steps S105 and S106, playback is performed only once from the I picture indicated by the value of the playback speed PL set initially. Namely, for example, if the value of the playback speed PH set in Step S102 is 3, for triple-speed playback, then the search first finds the I picture I1 shown in FIG. 2B and PH becomes 2 in Step S105, the search next finds I picture I2 and PH becomes 1 in Step S105, the search next finds I picture I3 and PH becomes 0 in Step S105, so control procedure moves to Step S107 where the current I picture I3 is outputted. To wit, in triple-speed playback mode, one out of every three I pictures is outputted.

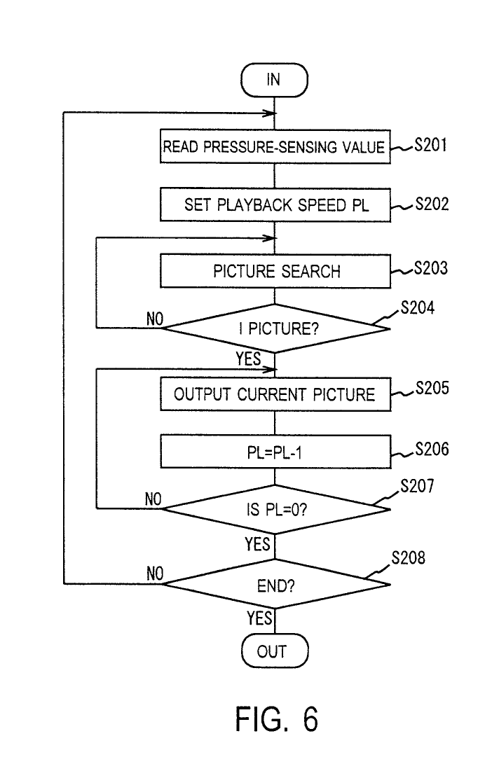

FIG. 6 is a flowchart showing the low-speed playback processing routine S200 shown in FIG. 4. In Step S201, the pressure-sensing value is acquired from the controller 200, and in Step S202 the playback speed PL based on the pressure-sensing value thus acquired is read from the low-speed playback table shown in FIG. 3B and set.

In Step S203, a search for I pictures is performed among the pictures sequentially played back and restored, and in Step S204 a decision is made as to whether or not it is an I picture, and if “YES” then control processing moves to Step S205, but if “NO” then control processing moves back to Step S203.

In Step S205 the current picture, namely the I picture found in the search, is provided as an output.

In Step S206, the playback speed PL is decremented by 1, and in Step S207 a decision is made as to whether or not the decremented playback speed PL is equal to 0, and if “YES” then control processing moves to Step S208, but if “NO” then control processing moves back to Step S205.

In Step S208, a decision is made as to whether to end or not. If “YES” then control leaves this routine, but if “NO” then control processing moves back to Step S201. The order to end may be given by input from a specialized switch or when the pressure-sensing value becomes 0.

Based on the processing of Steps S206 and S207, playback is performed only once from the I picture indicated by the value of the playback speed PL set initially. Namely, for example, if the value of the playback speed PL set in Step S202 is 3 (a value corresponding to one-third speed), then the I picture found in Step S203, namely the current I picture I1 is output and PL becomes 2 in Step S206, the current I picture I1 is output and PL becomes 1 in Step S206, and the current I picture I1 is played back and PL becomes 0 in Step S206, so control processing moves to Step S208. To wit, in one-third speed playback mode, one out of every three I pictures is outputted.

As described above, with the present embodiment, playback is performed at a speed depending on the pressure-sensing value, so the user interface can be improved compared to the case of variable-speed playback with a simple ON/OFF switch.

It should be noted that it is also possible to find the percent change from the previous pressure-sensing value to the current pressure-sensing value, and have playback be performed at a speed which depends on this percent change. For example, if the previous pressure-sensing value is 100 and the current pressure-sensing value is 50, then the percent change is 50%, so the playback speed may be made one-half the previous playback speed.

In addition, tables which are the reverse of those shown in FIGS. 3A and 3B, namely the tables wherein low pressure-sensing values are allocated to higher playback speeds may be used.

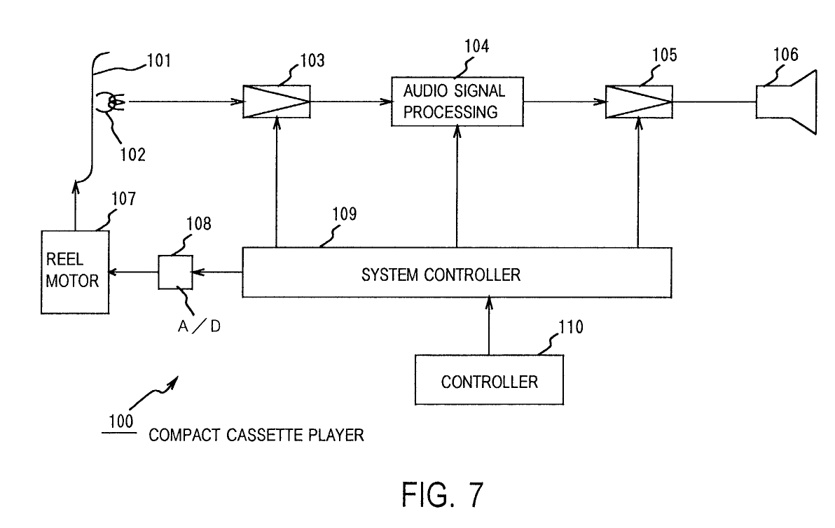

FIG. 7 is a diagram showing another embodiment. In the embodiment shown in FIG. 7, the pressure-sensing value is used in the variable-speed playback of a compact cassette recorder 100.

A compact cassette recorder 100 shown in FIG. 7 includes a magnetic head 102 that plays back audio signals from a magnetic tape 101, an amplifier 103 that amplifies the playback signal from the magnetic head 102, an audio signal processing circuit 104 that performs various types of audio signal processing on the output from the amplifier 103, an amplification circuit 105 that amplifies the output of the audio signal processing circuit 104, a speaker 106 that converts the output of the amplification circuit 105 into sound, a reel motor 107 that turns the reel of the magnetic tape 101, thus moving the magnetic tape 101, a system controller 109 that controls the amplifiers 103 and 105 and the audio signal processing circuit 104 and also outputs a digital drive signal based on the pressure-sensing value from a controller 110, an A/D converter 108 that converts the digital drive signal from the system controller 109 into an analog drive signal which is supplied to the reel motor 107, and a controller 110 that supplies a drive signal to the reel motor 107 via the system controller 109 and A/D converter 108, thereby obtaining the desired playback speed by moving the magnetic tape 101 at a speed that depends on the pressure-sensing value.

Since the playback speed at the time that playback of media recorded with sound is freely controlled with a pressure-sensitive switch, the operation by the user becomes direct control, so the user interface is improved in this manner.

FIG. 8 is a perspective view of controller 200 connected to entertainment system 500. The controller 200 is removably connected to the entertainment system 500, and the entertainment system 500 is connected to television monitor 408.

The entertainment system 500 reads the program for a computer game from recording media upon which that program is recorded and by executing the program, displays characters on the television monitor 408. The entertainment system 500 has various built-in functions for DVD (Digital Versatile Disc) playback, CDDA (compact disc digital audio) playback and the like. The signals from the controller 200 are also processed as one of the aforementioned control functions within the entertainment system 500, and the content thereof may be reflected in the movement of characters and the like, on the television monitor 408.

While this depends also on the content of the computer game program, controller 200 may be allocated functions for moving the characters display on the television monitor 408 in the directions up, down, left or right.

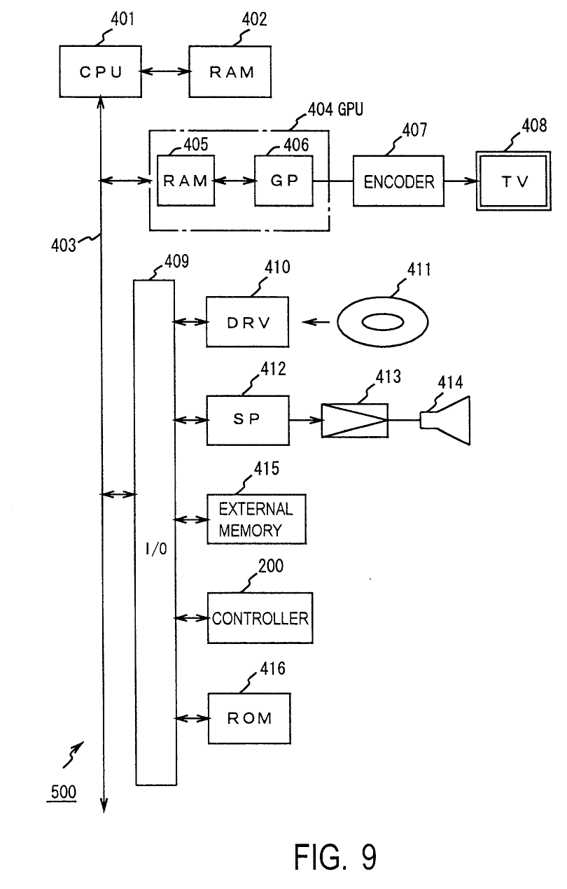

With reference to FIG. 9, here follows a description of the interior of the entertainment system 500 shown in FIG. 8. FIG. 9 is a block diagram of the entertainment system 500.

A CPU 401 is connected to RAM 402 and a bus 403, respectively. Connected to bus 403 are a graphics processor unit (GPU) 404 and an input/output processor (I/O) 409, respectively. The GPU 404 is connected via an encoder 407 for converting a digital RGB signal or the like into the NTSC standard television format, for example, to a television monitor (TV) 408 as a peripheral. Connected to the I/O 409 are a driver (DRV) 410 used for the playback and decoding of data recorded upon an optical disc 411, a sound processor (SP) 412, an external memory 415 consisting of flash memory, controller 200 and a ROM 416 which records the operating system and the like. The SP 412 is connected via an amplifier 413 to a speaker 414 as a peripheral.

Here, the external memory 415 may be a card-type memory consisting of a CPU or a gate array and flash memory, which is removably connected via a connector 511 to the entertainment system 500 shown in FIG. 8. The controller 200 is configured such that, when a plurality of buttons provided thereupon are pushed, it gives instructions to the entertainment system 500. In addition, the driver 410 is provided with a decoder for decoding images encoded based upon the MPEG standard.

The description will be made now as to how the images will be displayed on the television monitor 408 based on the operation of controller 200. It is assumed that data for objects consisting of polygon vertex data, texture data and the like recorded on the optical disc 411 is read by the driver 410 and stored in the RAM 402 of the CPU 401.

When instructions from the player via controller 200 are provided as an input to the entertainment system 500, the CPU 401 calculates the three-dimensional position and orientation of objects with respect to the point of view based on these instructions. Thereby, the polygon vertex data for objects defined by X, Y, Z coordinate values are modified variously. The modified polygon vertex data is subjected to perspective conversion processing and converted into two-dimensional coordinate data.

The regions specified by two-dimensional coordinates are so-called polygons. The converted coordinate data, Z data and texture data are supplied to the GPU 404. Based on this converted coordinate data, Z data and texture data, the GPU 404 performs the drawing process by writing texture data sequentially into the RAM 405. One frame of image data upon which the drawing process is completed, is encoded by the encoder 407 and then supplied to the television monitor 408 and displayed on its screen as an image.

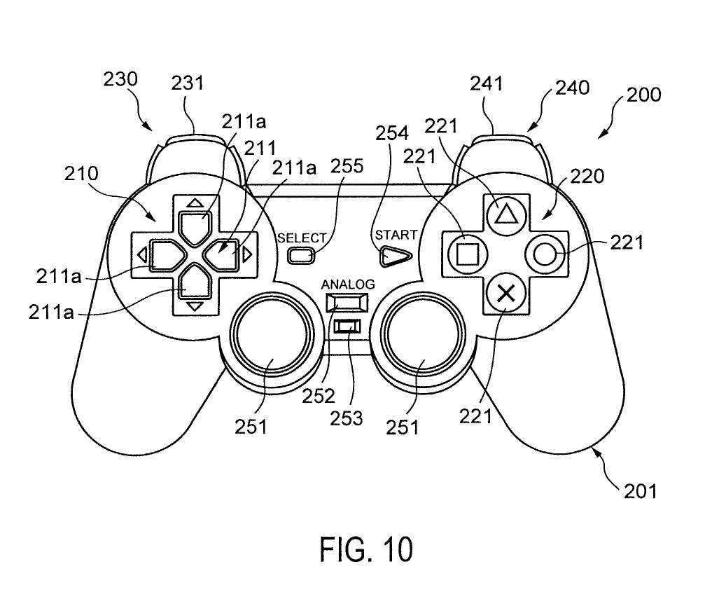

FIG. 10 is a top view of controller 200. The controller 200 consists of a unit body 201 on the top surface of which are provided first and second control parts 210 and 220, and on the side surface of which are provided third and fourth control parts 230 and 240 of the controller 200.

The first control part 210 of the controller is provided with a cruciform control unit 211 used for pushing control, and the individual control keys 211a extending in each of the four directions of the control unit 211 form a control element. The first control part 210 is the control part for providing movement to the characters displayed on the screen of the television receiver, and has the functions for moving the characters in the up, down, left and right directions by pressing the individual control keys 211a of the cruciform control unit 211.

The second control part 220 is provided with four cylindrical control buttons 221 (control elements) for pushing control. The individual control buttons 221 have identifying marks` such as “◯” (circle), “X” (cross), “Δ” (triangle) and “□” (quadrangle) on their tops, in order to easily identify the individual control buttons 221. The functions of the second control part 220 are set by the game program recorded upon the optical disc 411, and the individual control buttons 221 may be allocated functions that change the state of the game characters, for example. For example, the control buttons 221 may be allocated functions for moving the left arm, right arm, left leg and right leg of the character.

The third and fourth control parts 230 and 240 of the controller have nearly the same structure, and both are provided with two control buttons 231 and 241 (control elements) for pushing control, arranged above and below. The functions of these third and fourth control parts 230 and 240 are also set by the game program recorded upon the optical disc, and may be allocated functions for making the game characters do special actions, for example.

Moreover, two joy sticks 251 for performing analog operation are provided upon the unit body 201 shown in FIG. 10. The joy sticks 251 can be switched and used instead of the first and second control parts 210 and 220 described above. This switching is performed by means of an analog selection switch 252 provided upon the unit body 201. When the joy sticks 251 are selected, a display lamp 253 provided on the unit body 201 lights, indicating the state wherein the joy sticks 251 are selected.

It is to be noted that on unit body 201 there are also provided a start switch 254 for starting the game and a select switch 255 for selecting the degree of difficulty or the like at the start of a game, and the like.

Controller 200 is held by the left hand and the right hand of a user and is operated by the other fingers, of the user, and in particular the user's thumbs of the user are able to operate most of the buttons on the top surface.

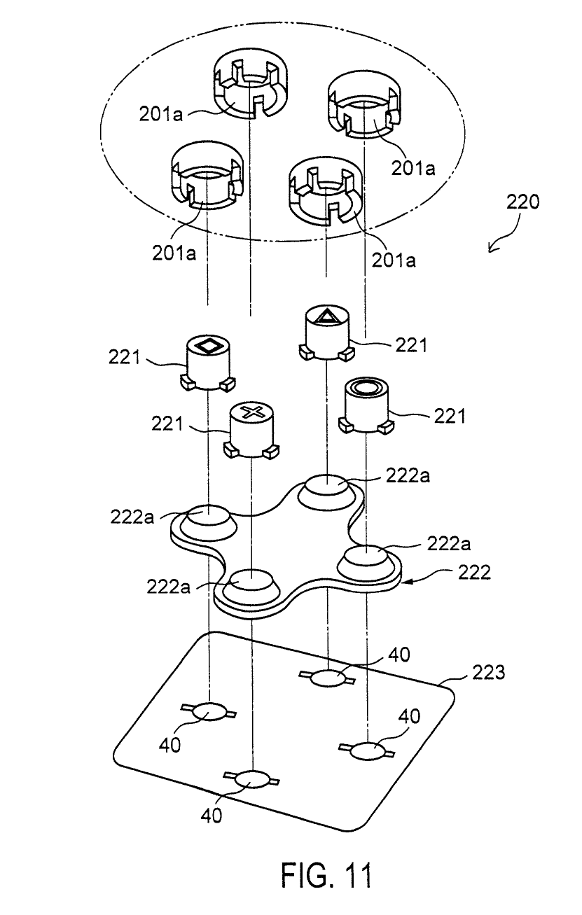

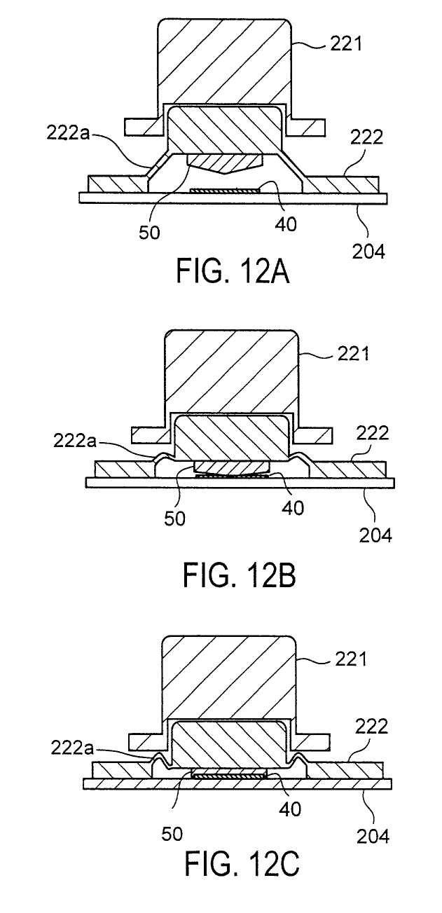

FIG. 11 and FIGS. 12A-12C are, respectively, in exploded perspective view and cross-sectional views showing the second control part of the controller.

As shown in FIG. 11, the second control part 220 consists of four control buttons 221 which serve as the control elements, an elastic body 222, and a sheet member 223 provided with resistors 40. The individual control buttons 221 are inserted from behind through insertion holes 201a formed on the upper surface of the unit body 201. The control buttons 221 inserted into the insertion holes 201a are able to move freely in the axial direction.

The elastic body 222 is made of insulating rubber or the like and has elastic areas 222a which protrude upward, and the lower ends of the control buttons 221 are supported upon the upper walls of the elastic areas 222a. When the control buttons 221 are pressed, the inclined-surface portions of these elastic areas 222a flex so that the upper walls move together with the control buttons 221. On the other hand, when the pushing pressure on the control buttons 221 is released, the flexed inclined-surface portions of elastic areas 222a elastically return to their original shape, pushing up the control buttons 221. The elastic body 222 functions as a spring means whereby control buttons 221 which had been pushed in by a pushing action are returned to their original positions. As shown in FIGS. 12A-12C, conducting members 50 are attached to the rear surface of the elastic body 222.

The sheet member 223 consists of a membrane or other thin sheet material which has flexibility and insulating properties. Resistors 40 are provided in appropriate locations on this sheet member 223 and these resistors 40 and conducting member 50 are each disposed such that they face one of the control buttons 221 via the elastic body 222. The resistors 40 and conducting members 50 form pressure-sensitive devices. These pressure-sensitive devices consisting of resistors 40 and conducting members 50 have resistance values that vary depending on the pushing pressure received form the control buttons 221.

To describe this in more detail, as shown in FIGS. 12A-12C, the second control part 220 is provided with control buttons 221 as control elements, an elastic body 222, conducting members 50 and resistors 40. Each conducting member 50 may be made of conductive rubber which has elasticity, for example, and has a conical shape with its center as a vertex. The conducting members 50 are adhered to the inside of the top surface of the elastic areas 222a formed in the elastic body 222.

In addition, the resistors 40 may be provided on an internal board 204, for example, opposite the conducting members 50, so that the conducting members 50 come into contact with resistors 40 together with the pushing action of the control buttons 221. The conducting member 50 deforms, depending on the pushing force on the control button 221 (namely the contact pressure with the resistor 40), so as shown in FIG. 12B and 12C, the surface area in contact with the resistor 40 varies depending on the pressure. To wit, when the pressing force on the control button 221 is weak, as shown in FIG. 12B, only the area near the conical tip of the conducting member 50 is in contact. As the pressing force on the control button 221 becomes stronger, the tip of the conducting member 50 deforms gradually so the surface area in contact expands.

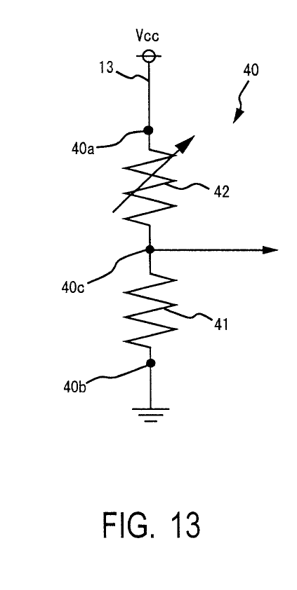

FIG. 13 is a diagram showing an equivalent circuit for a pressure-sensitive device consisting of a resistor 40 and conducting member 50. As shown in this diagram, the pressure-sensitive device is inserted in series in a power supply line 13, where the voltage V_{cc} is applied between the electrodes 40a and 40b. As shown in this diagram, the pressure-sensitive device is divided into a variable resistor 42 that has the relatively small resistance value of the conducting member 50, and a fixed resistor 41 that has the relatively large resistance value of the resistor 40. Among these, the portion of the variable resistor 42 is equivalent to the portion of resistance in the contact between the resistor 40 and the conducting member 50, so the resistance value of the pressure-sensitive device varies depending on the surface area of contact with the conducting member 50.

When the conducting member 50 comes into contact with the resistor 40, in the portion of contact, the conducting member 50 becomes a bridge instead of the resistor 40 and a current flows, so the resistance value becomes smaller in the portion of contact. Therefore, the greater the surface area of contact between the resistor 40 and conducting member 50, the lower the resistance value of the pressure-sensitive device becomes. In this manner, the entire pressure-sensitive device can be understood to be a variable resistor. It should be noted that FIGS. 12A-12C show only the contact portion between the conducting member 50 and resistor 40 which forms the variable resistor 42 of FIG. 13, but the fixed resistor 41 of FIG. 13 is omitted from FIG. 12A-12C.

In the preferred embodiment, an output terminal is provided near the boundary between the variable resistor 42 and fixed resistor 41, namely near the intermediate point of the resistors 40, and thus a voltage stepped down from the applied voltage V_{cc} by the amount the variable resistance is extracted as an analog signal corresponding to the pushing pressure by the user on the control button 221.

First, since a voltage is applied to the resistor 40 when the power is turned on, even if the control button 221 is not pressed by the user, a fixed analog signal (voltage) Vₘᵢₙ is provided as the output from the output terminal 40c. Next, even if the control button 221 is pressed, the resistance value of this resistor 40 does not change until the conducting member 50 contacts the resistor 40, so the output from the resistor 40 remains unchanged at Vₘᵢₙ. If the control button 221 is pushed further and the conducting member 50 comes into contact with the resistor 40, the surface area of contact between the conducting member 50 and the resistor 40 increases in response to the pushing pressure on the control button 221, and thus the resistance of the resistor 40 is reduced so the analog signal (voltage) output from the output terminal 40c of the resistor 40 increases. Furthermore, the analog signal (voltage) output form the output terminal 40c of the resistor 40 reaches the maximum Vₘₐₓ when the conducting member 50 is most deformed.

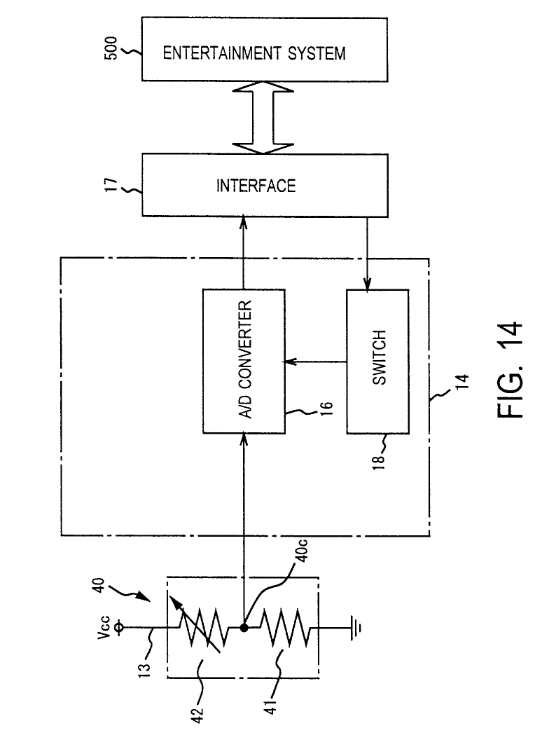

FIG. 14 is a block diagram showing the main parts of the controller 200.

An MPU 14 mounted on the internal board of the controller 200 is provided with a switch 18, an A/D converter 16. The analog signal (voltage) output from the output terminal 40c of the resistor 40 is provided as the input to the A/D converter 16 and is converted to a digital signal.

The digital signal output from the A/D converter 16 is sent via an interface 17 provided upon the internal board of the controller 200 to the entertainment system 500 and the actions of game characters and the like are executed based on this digital signal.

Changes in the level of the analog signal output from the output terminal 40c of the resistor 40 correspond to changes in the pushing pressure received form the control button 221 (control element) as described above. Therefore, the digital signal outputted from the A/D converter 16 corresponds to the pushing pressure on the control button 221 (control element) from the user. If the actions of the game characters and the like are controlled based on the digital signal that has such a relationship with the pushing pressure from the user, it is possible to achieve smoother and more analog-like action than with control based on a binary digital signal based only on zeroes and ones.

The configuration is such that the switch 18 is controlled by a control signal sent from the entertainment system 500 based on a game program recorded on an optical disc 411. When a game program recorded on optical disc is executed by the entertainment system 500, depending on the content of the game program, a control signal is provided as output to specify whether the A/D converter 16 is to function as a means of providing output of a multi-valued analog signal, or as a means of providing a binary digital signal. Based on this control signal, the switch 18 is switched to select the function of the A/D converter 16.

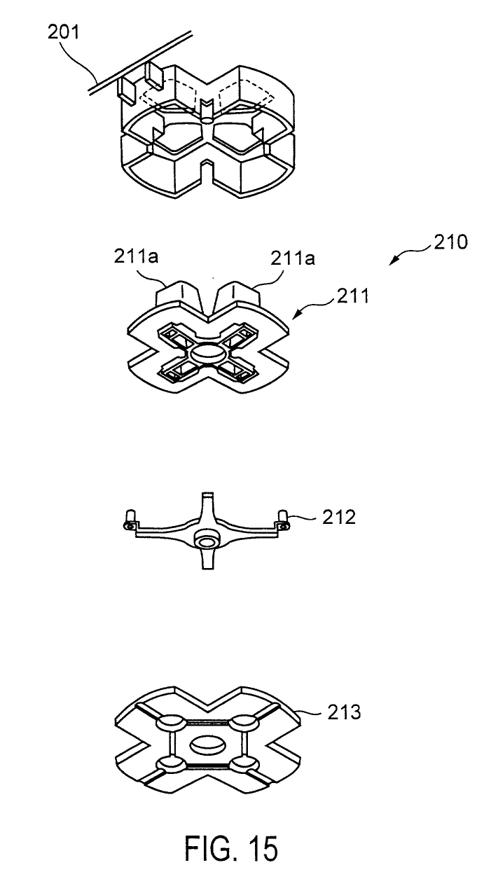

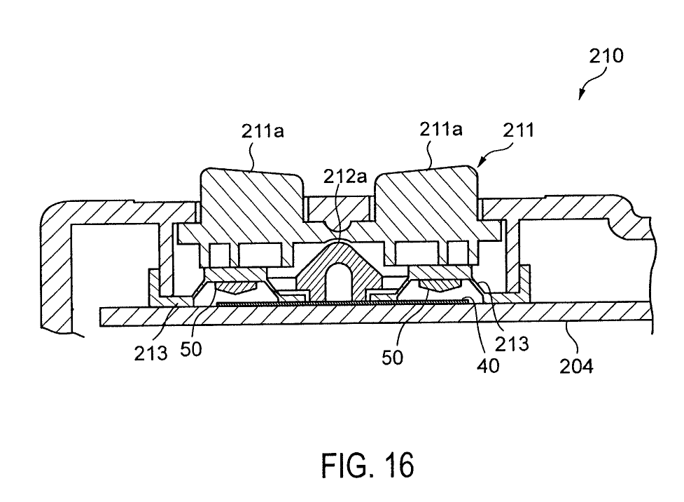

FIGS. 15 and 16 show an example of the configuration of the first control part of the controller.

As shown in FIG. 15, the first control part 210 includes a cruciform control unit 211, a spacer 212 that positions this control unit 211, and an elastic body 213 that elastically supports the control unit 211. Moreover, as shown in FIG. 16, a conducting member 50 is attached to the rear surface of the elastic body 213, and the configuration is such that resistors 40 are disposed at the positions facing the individual control keys 211a (control elements) of the control unit 211 via the elastic body 213.

The overall structure of the first control part 210 has already been made public knowledge in the publication of unexamined Japanese patent application No. JP-A-H8-163672. The control unit 211, however, uses a hemispherical projection 212a formed in the center of the spacer 212 as a fulcrum, and the individual control keys 211a (control elements) are assembled such that they can push on the resistor 40 side (see FIG. 16).

Conducting members 50 are adhered to the inside of the top surface of the elastic body 213 in positions corresponding to the individual control keys 211a (control elements) of the cruciform control unit 211. In addition, the resistors 40 with a single structure are disposed such that they face the individual conducting members 50.

When the individual control keys 211a which are control elements are pushed, the pushing pressure acts via the elastic body 213 on the pressure-sensitive devices consisting of a conducting member 50 and resistor 40, so that its electrical resistance value varies depending on the magnitude of the pushing pressure.

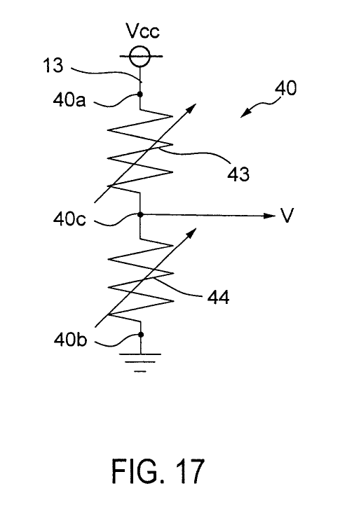

FIG. 17 is a diagram showing the circuit configuration of the resistor. As shown in this diagram, the resistor 40 is inserted in series in a power supply line 13, where a voltage is applied between the electrodes 40a and 40b. The resistance of this resistor 40 is illustrated schematically, as shown in this diagram; the resistor 40 is divided into first and second variable resistors 43 and 44. Among these, the portion of the first variable resistor 43 is in contact, respectively, with the conducting member 50 that moves together with the control key (up directional key) 211a for moving the character in the up direction, and with the conducting member 50 that moves together with the control key (left directional key) 211a for moving the character in the left direction, so its resistance value varies depending on the surface area in contact with these conducting members 50.

In addition, the portion of the second variable resistor 44 is in contact, respectively, with the conducting member 50 that moves together with the control key (down directional key) 211a for moving the character in the down direction, and with the conducting member 50 that moves together with the control key (right directional Key) 211a for moving the character in the right direction, so its resistance value varies depending on the surface area in contact with these conducting members 50.

Moreover, an output terminal 40c is provided intermediate between the variable resistors 43 and 44, and an analog signal corresponding to the pushing pressure on the individual control keys 211a (control elements) is providing as output from this output terminal 40c.

The output from the output terminal 40c can be calculated from the ratio of the split in resistance value of the first and second variable resistors 43 and 44. For example, if R1 is the resistance value of the first variable resistor 43, R2 is the resistance value of the second variable resistor 44 and V_{cc} is the power supply voltage, then the output voltage V appearing at the output terminal 40c can be expressed by the following equation.

V=V_{cc}×R2/(R1+R2)

Therefore, when the resistance value of the first variable resistor 43 decreases, the output voltage increases, but when the resistance value of the second variable resistor 44 decreases, the output voltage also decreases.

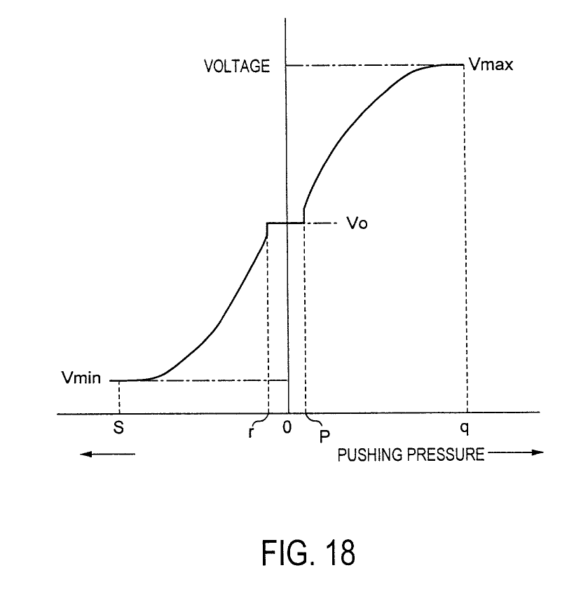

FIG. 18 is a graph showing the characteristic of the analog signal (voltage) outputted from the output terminal of the resistor.

First, since a voltage is applied to the resistor 40 when the power is turned on, even if the individual control keys 211a of the control unit 211 are not pressed, a fixed analog signal (voltage) V₀ is provided as output form the output terminal 40c (at position 0 in the graph).

Next, even if one of the individual control keys 221a is pressed, the resistance value of this resistor 40 does not change until the conducting member 50 contacts the resistor 40, and the output from the resistor 40 remains unchanged at V₀.

Furthermore, if the up-directional key or left-directional key is pushed until the conducting member 50 comes into contact with the first variable resistor 43 portion of the resistor 40 (at position p in the graph), thereafter the surfaced area of contact between the conducting member 50 and the first variable resistor 43 portion increases in response to the pushing pressure on the control key 221a (control elements), and thus the resistance of that portion is reduced so the analog signal (voltage) output from the output terminal 40c of the resistor 40 increases. Furthermore, the analog signal (voltage) output form the output terminal 40c of the resistor 40 reaches the maximum Vₘₐₓ when the conducting member 50 is most deformed (at position q in the graph).

On the other hand, if the down-directional key or right-directional key is pushed until the conducting member 50 comes into contact with the second variable resistor 44 portion of the resistor 40 (at position r in the graph), thereafter the surface area of contact between the conducting member 50 and the second variable resistor 44 portion increases in response to the pushing pressure on the control key 211a (control elements), and thus the resistance of that portion is reduced, and as a result, the analog signal (voltage) output from the output terminal 40c of the resistor 40 decreases.

Furthermore, the analog signal (voltage) output form the output terminal 40c of the resistor 40 reaches the minimum Vₘᵢₙ when the conducting member 50 is most deformed (at position s in the graph).

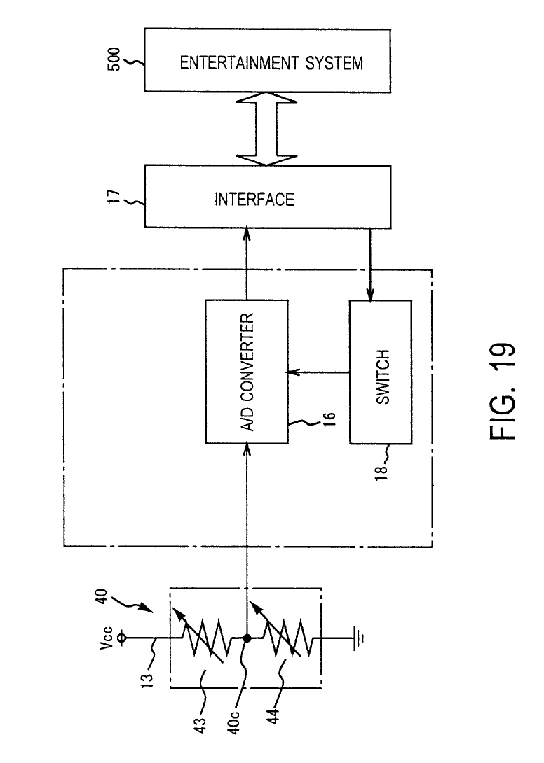

As shown in FIG. 19, the analog signal (voltage) output from the output terminal 40c of the resistor 40 is provided as input to an A/D converter 16 and converted to a digital signal. It is to be noted that the function of the A/D converter 16 is shown in FIG. 19 is as described previously based on FIG. 14, so a detailed description shall be omitted here.

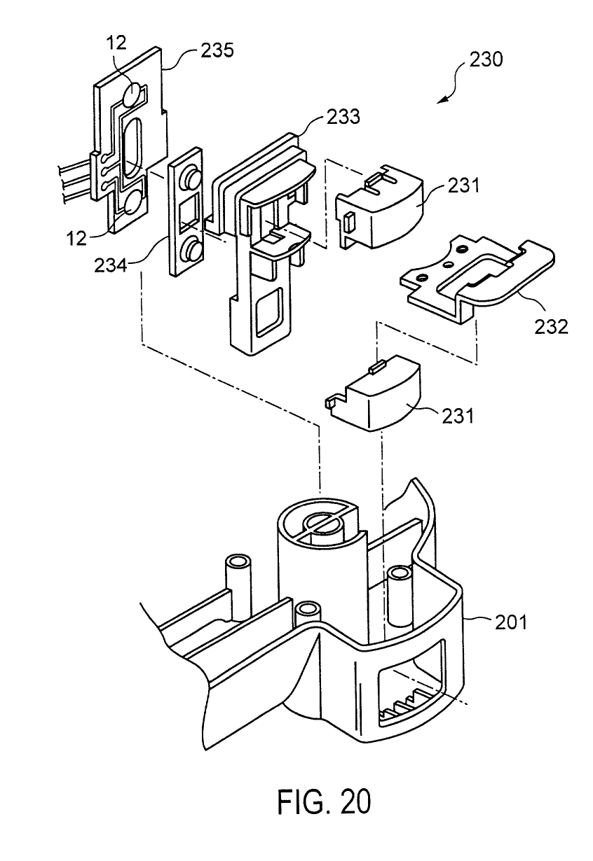

FIG. 20 is an exploded perspective view of the third control part of the controller.

The third control part 230 consists of two control buttons 231, a spacer 232 for positioning these control buttons 231 within the interior of the controller 200, a holder 233 that supports these control buttons 231, an elastic body 234 and an internal board 235, having a structure wherein resistors 40 are attached to appropriate locations upon the internal board 235 and conducting members 50 are attached to the rear surface of the elastic body 234.

The overall structure of the third control part 230 also already has been made public knowledge in the publication of unexamined Japanese patent application No. JP-A-H8-163672. The individual control buttons 231 can be pushed in while being guided by the spacer 232, the pushing pressure when pressed acts via the elastic body 234 on the pressure-sensitive device consisting of a conducting member 50 and resistor 40. The electrical resistance value of the pressure-sensitive device varies depending on the magnitude of the pushing pressure it receives.

It is noted that the fourth control part 240 has the same structure as that of the third control part 230 described above.

Within the aforementioned description, FIG. 4 shows a flowchart for variable-speed playback. This program may be supplied either recorded alone upon an optical disc or other recording medium, or recorded upon said recording medium together with the game software as part of the game software. These programs are run by the entertainment system 500 and executed by its CPU.

Here, the meaning of supplying the program for setting parameter values recorded individually on a recording medium has the meaning of preparing it in advance as a library for software development. As is common knowledge, at the time of developing software, writing all functions requires an enormous amount of time. However, if the software functions are divided by the type of function, for example, for moving objects and the like, they can be used commonly by various types of software, so more functions can be included.

To this end, a function such as that described in this preferred embodiment that can be used commonly may be provided to the software manufacturer side as a library program. When general functions like this are supplied as external programs in this manner, it is sufficient for the software manufacturers to write only the essential portions of the software.

While an embodiment was described above, the present invention may also assume the following alternative embodiment. In the described, the pressure-sensing value as pushed by the user is used as is. However, in order to correct for differences in the body weights of users or differences in how good their reflexes are, it is possible to correct the maximum value of the user pressure-sensing value to the maximum game pressure-sensing value set by the program, and intermediate values may be corrected proportionally and used. This type of correction is performed by preparing a correction table. In addition, the user pressure-sensing value can be corrected based upon a known function. Moreover, the maximum value of the user pressure-sensing value rate of change may be corrected to the maximum game pressure-sensing value rate of change set in the program, and intermediate values can be proportionally corrected and used. For more details about this method, refer to the present inventors' Japanese patent application No. 2000-40257 and the corresponding PCT application JP/(Applicant's file reference No. SC00097).

Due to this invention, the pushing of a simple ON/OFF switch or holding it down for variable-speed playback can be made an easier-to-use interface for the user. In addition, by means of this invention, the user can use a pressure-sensitive switch to freely control the playback speed at the time of playback of media recorded with sound, achieving direct control based on the operation of the user. As a result, the user interface can be improved.

1. Electronic equipment comprising:
a switch and pressure-sensitive means connected to said switch,
a processing apparatus that performs playback processing at a speed depending on the output of said switch; and
output means that outputs the results of processing of said processing apparatus, wherein
said processing apparatus changes a playback speed to a speed depending on an output value of said switch.

2. The electronic equipment according to claim 1, wherein
said processing apparatus changes the playback speed depending on a percent change in a magnitude of the output value of said switch.

3. The electronic equipment according to claim 1, wherein
said processing apparatus changes the playback speed depending on the magnitude of the output value of said switch.

4. A recording medium on which is recorded a computer-readable and executable software program that performs processing by taking as instructions from an output of a controller which has pressure-sensitive means, wherein
said software program changes the playback speed depending on an output value of said controller.

5. The recording medium according to claim 4, wherein
said software program changes the playback speed depending on a percent change in the magnitude of the output value of said controller.

6. The recording medium according to claim 3, wherein
said software program changes the playback speed depending on the magnitude of the output value of said controller.

7. A method of generating images or sound, comprising the steps of:
a using a switch having pressure-sensitive means;
sensing a pushing pressure of a user on said switch, by said pressure-sensitive means to generate a pressure-sensing signal,
determining a playback speed according to said pressure-sensing signal, and
performing variable-speed playback at the playback speed thus determined.

8. The method according to claim 7, wherein
said determining step changes the playback speed depending on the magnitude of an output value of said switch.

9. The method according to claim 7, wherein
said determining step determines the playback speed depending on a percent change in magnitude between a pressure-sensing signal in a previous operation and a pressure-sensing signal in a current operation.

10. The method according to claim 7, wherein
said performing step at the time of variable-speed playback of MPEG-compressed images, performs the variable-speed playback using I pictures only.
